(19) United States
(12) Patent Application Publication
(10) Pub. No.: US 2026/0048567 A1
(43) Pub. Date: Feb. 19, 2026

(54) METHOD, DECORATIVE FILM AND HIGH-PERFORMANCE COATING FOR DECORATING AND EMBOSSING A MATERIAL

(71) Applicant: Giorgio MACOR, Villorba (IT)

(72) Inventor: Giorgio MACOR, Villorba (IT)

(21) Appl. No.: 19/287,608

(22) Filed: Jul. 31, 2025

(30) Foreign Application Priority Data
Aug. 1, 2024 (IT) 102024000017974
Nov. 21, 2024 (IT) 102024000026310
Jul. 30, 2025 (IT) 102025000019795
Jul. 30, 2025 (IT) 102025000019819

(51) Int. Cl. B32B 3/30; B29D 7/01; B29K 33/04; B32B 7/12; B32B 27/30

(52) U.S. Cl. CPC B32B 3/30; B29D 7/01; B32B 7/12; B32B 27/304; B29K 2033/04; B32B 2255/10; B32B 2307/584; B32B 2405/00; B32B 2451/00

(57) ABSTRACT

The invention relates to a method for decorating a material and a high-performance decorative film. In particular, a printed and embossed ready-to-laminate film (FIG. 4) is presented, comprising a decorative layer, an embossable layer (with photo-curable formulation and thermoplastic resin), and a pre-photopolymerized, thermally reactivatable adhesive layer. The formulation and adhesive provide the film with flexibility and stability, even with high loads of anti-abrasive fillers (e.g., aluminum oxide), drastically reducing polymer relaxation and deformation. Embossing of the film preferably occurs via cast-curing (FIG. 3), allowing faithful replication of textures and variable gloss. This film is specifically designed for offline lamination, overcoming issues of traditional adhesives and direct applications, such as blocking on thin films and texture alteration.

The present invention relates to a system for producing a decorated and textured support, comprising the method, the machinery, the decorative film, and the embossable layer. In particular, the invention relates to a ready-to-laminate film (ready to laminate) decorated and textured by digital printing and a method for its production.

The present invention falls within the technical sector of materials and for the production of panels to produce flooring, coverings, furniture and, more generally, for architectural and design surfaces.

The present invention exploits the combination of traditional technologies, which offer high mechanical, chemical-physical properties, low costs, and the versatility of digital technologies that allow total customization and high precision.

### STATE OF THE ART

Panels for producing flooring and furniture that reproduce the color and tactile feel of wood and other natural materials are generally made of wood-derived substrates such as HDF, MDF, and particleboard, or synthetic substrates such as polyester, PVC (SPC, LVT, WPC), and polyolefins such as PE and PP.

The state of the art for traditional wooden furniture and flooring (MDF/HDF/particleboard/plywood) involves the use of decorative papers (printed) applied to the support and normally protected by the application of aminoplastic resins. The process takes place in continuous or discontinuous presses through the application of pressure and heat. The resulting surface is extremely resistant to scratches and abrasion. The product thus obtained is commonly called laminate.

Alternatively, especially for furniture, decorative papers, called “finish papers,” can be used, which are normally applied cold with the aid of adhesives. Finish paper consists of decorative paper+protection and is normally embossed.

Similarly, plastic films are normally used to decorate synthetic substrates and are usually hot-laminated onto the substrate itself. The lamination of the decorated film on the surface of the support to be decorated can take place continuously, for example, by calenders, double belt presses, or discontinuously by flat presses or membrane presses. Pressure, temperature, and lamination time depend on the materials to be laminated. For example, in the case of PVC-based materials, calender lamination is a continuous process and takes place at 170-200° C. for a few seconds, while press lamination takes place at 120-160° C. for several minutes with subsequent cooling to stabilize.

Lamination normally occurs after the extrusion phase of the support to be decorated. Typically, in the case of PVC, the material exits the extruder at a speed of 1-5 m/min with a temperature around 140-200° C. The material passes through one or more pairs of calenders to achieve the desired width and flatten the surface. Normally, during or after the lamination phase, an embossing element is used to create the texture of the material to be reproduced, such as stone and wood. These embossing elements are generally made of metal, and the textures are created through mechanical and/or chemical and/or laser processing.

Similar to finish paper, finished films (e.g., ex-Profol DE or ex-Renolit DE) are available on the market for plastic substrates. These finished films consist of decorated plastic film+protection layer+finishing layer (topcoat) and are generally embossed. The finished films may have an adhesive on the lamination side and are applied by means of heat and pressure or cold with the aid of specific adhesives.

In recent years, PVC flooring is experiencing a renaissance with the introduction of the so-called LVT (Luxury Vinyl Tile) and SPC (Stone Plastic Composite), where the product is presented as a plank suitable for floating or self-adhesive installation and characterized by low thickness (3-5 mm), useful in renovations. Since LVT/SPC is a design product, the market would welcome the use of digital technologies for printing, allowing flexibility and just-in-time production.

Traditional technology involves the lamination of the substrate (core), decorative film, and protective film (commonly called Wear Layer). Normally, during lamination, an embossed element is used to create the texture of the material to be reproduced, such as stone or wood. To guarantee adhesion between the transparent protective layer and the decorative film, the ink must have thermoplastic behavior; in fact, gravure inks normally used for printing decorative films are predominantly solvent-based and generally contain solubilized or dispersed PVC to promote adhesion with the protective layer (Wear Layer). The protective layer or wear layer consists of a thick film (300-500μ) of transparent polymer (PVC, PP, PET) and is applied by heat and pressure in continuous presses, discontinuous presses, or engraved cylinders. The surface is then generally finished by applying a photocurable coating (topcoat) to achieve the desired gloss and impart scratch, chemical, and stain resistance.

The immediate choice, for the decoration of plastic films, would be to replace gravure printing with direct inkjet printing on plastic films. This would allow customers upstream integration simplifying film procurement times, especially for new designs. In fact, except for rare exceptions, due to management complexity and excess productivity, the printed film is purchased and not produced in-house by flooring manufacturers. However, this approach presents significant difficulties. The commonly used photopolymerizable inkjet inks are not thermoplastic in nature, which would prevent the wear layer from adhering correctly to the printed inks, causing delamination. On the other hand, if solvent-based inkjet inks show better adhesion, they are not easily manageable with single-pass printers due to problems related to evaporation and process control, and the same applies to water-based inkjet inks, which also often have no affinity with thermoplastic films and offer inadequate print quality, in addition to requiring the use of heat which can cause stretching and distortions on thermosensitive plastic films.

As an alternative to using pre-printed decorated films, direct printing on panels intended for the production of flooring and furniture has been considered an obvious choice. However, direct printing also presents significant challenges. It normally involves the creation of a printing layer (ink receiving layer), which is usually the background white. This layer is crucial for color reproducibility over time, a fundamental aspect to ensure that a product made today can be faithfully replicated over time. Droplet Expansion (or dot gain) is an essential parameter for color creation, and a background white applied with non-constant grammage or photopolymerized non-uniformly compared to the standard can lead to significant differences in the final color. Numerous variables in a production line, such as ambient temperature variations (with consequent modification of paint viscosity) or aging of UV lamps, can negatively affect this process. Furthermore, since the panels are not perfectly flat, to avoid damaging the print heads, printing takes place at distances of no less than 2 mm from the substrate, and very often even at 3 mm, which worsens the precision of droplet positioning on the substrate (droplet placement). On the contrary, printing on film offers countless advantages in terms of process control. The films used are normally white and it is easier to control their color during production, in addition to the possibility of printing at closer distances from the film, even at just 0.5 mm, significantly improving droplet placement and color reproducibility.

To overcome the mentioned limitations, various technologies have been proposed for digital decoration of LVT floors, for example patent US20180319148A1 provides for the use of water-based ink and subsequent lamination. Patent EP3095613B2 provides for the use of water-based ink containing a polyurethane resin and subsequent lamination. Patent US20200189250A1 provides for the use of a photocrosslinkable ink to which an adhesive layer is applied and subsequent lamination. Patent WO2017017473A1 provides for the use of a photocrosslinkable ink in which a vinyl resin is dissolved. Application WO2008152137A2 provides for printing on thermoplastic films, protecting the print with a photocrosslinkable coating, laminating the decorated and coated film on a substrate to be decorated, possibly embossing it. The above-mentioned technologies, while providing a solution for digital decoration with subsequent lamination, do not solve all problems, and in particular the abrasion performance, texturizability and minimal substrate distortion.

Regardless of the technology employed, replacing the wear layer that protects the printing of the decorated film, is not technically simple. In fact, the decoration is protected with a photocrosslinkable coating that contains an anti-abrasive filler such as aluminum oxide. The photocrosslinkable coating, depending on the desired abrasion class, is applied in high quantities 100-200 g/mq. After polymerization, the photocrosslinkable coating shows a shrinkage of about 8-15% by volume, causing deformation of the support (defined as bowing/cupping/Bending). This phenomenon is strongly accentuated in the case of plastic material flooring and even more so when the material is tested, as per regulations, for dimensional stability for 6 hours at 80° C.

Several technologies have been developed that combine digital printing and at the same time protect the underlying decoration from abrasion and have high flexibility to avoid substrate deformation. As an example, application WO2022034546A1 provides for the use of photocrosslinkable formulations containing thermoplastic resins with direct application on panel but not specifically for application on film and subsequent lamination.

In addition to the previously mentioned technologies, to create three-dimensional surface structures, photocrosslinkable formulations could be used that are embossed by applying and simultaneously irradiating elements engraved transparent to UV light, for example using embossing films/papers (e.g. Ultracast ex-SAPPI). Another technology involves the use of hot-melt formulations that are applied to the surface to be protected and subsequently embossed with embossing elements. An example of this technology is HotCoating by Kleiberit (DE) which, however, has limitations as the hot-melt is polyurethane in nature and takes 48-96 hours to crosslink on wood derivatives and over 10 days on synthetic materials that do not contain residual moisture; therefore, decorated panels require a long time before they can be mechanically processed.

Furthermore, to improve product sustainability, flooring manufacturers are increasingly oriented towards PVC-free production, favoring PET and polyolefins and maximizing the use of recycled materials. While homopolymer PVC_film-PVC_core lamination is an established technology, the analogous PP_film-PP_core and PET_film-PET_core lamination is not as easy and it would be interesting to develop alternative technologies.

Therefore, it would be interesting to develop a flexible decoration technology both in decoration and in materials to be decorated, while satisfying the desired characteristics of abrasion resistance, scratch resistance and other properties listed such as those indicated in Standards EN 15468:2016 and/or EN 16511:2019. Furthermore, the method should be able to use traditional embossing technologies as well as digital texturization technologies, such as those described in WO2018069874A1 and WO2020039361A1.

Furthermore, the market would favorably view the possibility of individually decorating (single-plank) the floor planks. Most finished planks have a mechanical locking system to join them during installation. This profile is present on all four sides of the plank and is generally produced by profiling machines after decoration and cutting of the panels. During profiling, a bevel can be generated which is usually colored to make it homogeneous with the color of the plank surface. Also in this case, direct printing presents various limitations including the application of protective paint which, being applied at high grammages, typically 80-250 g/m², tends to dirty the bevel, the locking system and generate typical painting defects near the head and tail of the plank due to the non-uniformity of paint application at the entrance and exit from the piece in the applicator machine.

### Glossary

In the following GLOSSARY, the technical meanings of the terms used in this description and in the claims are better defined:

READY-TO-LAMINATE FILM: generally plastic or paper-based film, object of the invention, characterized by being composed of a decorative layer (printed or solid color), an embossable layer and, optionally, an adhesive applied on the side opposite to the decorated one.

TEXTURING/EMBOSSING: creation of a three-dimensional structure that can be both positive and negative.

EMBOSSABLE LAYER/EMBOSSABLE FORMULATION shaping of the layer formed by the said paint in such a way that the surface presents a three-dimensional pattern, i.e. alternating depressions and/or protrusions.

POLYMERIZATION: reaction whereby multiple molecules of the same compound, generally organic and low molecular weight (monomer), unite to form a multiple molecule (polymer) with higher molecular weight. It can occur by addition (see polyaddition), when it happens simply by sum of the monomer molecules to form a polymer whose percentage composition is therefore the same and the molecular weight multiple of that of the monomer; or by condensation (see polycondensation), when the union between the monomer molecules is accompanied by elimination of simple molecules (water, hydracids, etc.), so that the molecular weight of the resulting polymer is not exactly multiple of that of the monomer nor the percentage composition exactly equal. When there is union of monomers of different species, we speak more properly of copolymerization. In the case of photopolymerization, the reaction can occur by irradiation with UV rays, normally accelerated by the presence of photoinitiators.

PHOTOINITIATOR: compound that, following exposure to ultraviolet light, releases substances that activate the polymerization reactions of photocrosslinkable paints.

DRYING: removal of the solvent in the case of solvent-based paints or of the dispersing vehicle in the case of dispersed resin-based paints.

EMBOSSING ELEMENT: system capable of generating, by means of pressure and/or heat, a permanent imprint of a relief design. The element can for example consist of a calender, a mold, a double-belt press, a membrane press.

BENDING/CURLING/CUPPING: deformation of a substrate consequent to the application on it of other layers such as paints, inks, adhesives, plastic films. Normally the deformation is accentuated by heat. This deformation can present different trends.

PAINT/COATING/LACQUER: product intended to protect and/or decorate and/or improve the aesthetics of a substrate.

PHOTOCROSSLINKING/PHOTOCURING/RADIATION-CURING/ENERGY-CURING: crosslinking reaction in the presence or absence of photoinitiators, induced by irradiation using energetic radiation such as, in particular but not limited to, UV bulb or LED lamps, electron beam, or similar.

GLOSS/BRIGHTNESS (also shine or luster) of a material defines whether the final surface is matte or glossy. The unit of measurement is an index defined Gloss Units (abbreviated GU), or simply Gloss ranging from 0 to 100%. The measuring instrument is the reflectometer or glossmeter, which measures specular reflection, i.e., the intensity of reflected light, within a small area, on the reflection angle. More details on brightness measurement are contained in ISO 2813 standard.

Tg: The glass transition temperature of a polymer is the temperature region of the transition from a rigid “glassy” state to a flexible “rubbery” state.

CENTRAL DRUM: element on which printing and/or coating operations are performed.

HYPERSPECTRAL CAMERA: a hyperspectral camera is capable of acquiring an image and, for each pixel, the relative spectrum simultaneously, generating what is commonly called a “data cube”, thus combining Imaging and Spectroscopy. The “data cube” consists of a series of frames, each of which is an image line that is dispersed in wavelength and acquired by the sensor. It is therefore the spectral information line by line that is acquired by the sensor, while the spatial information will be reconstructed by software from the spectral ones.

DUAL-CURE: ability of a formulation to undergo 2 or more different crosslinking modes, such as: Radical photopolymerization. Cationic photopolymerization. Thermal crosslinking with reaction of various species better identified in the following pages. Photogeneration of acids. Photogeneration of bases.

SOLID COLOR: is a uniform monochromatic color and can be achieved using specific pigments (e.g., green or brown), mixing two or more colors (e.g., mixing two colored formulations) overlapping two or more colors (usually overlapping transparent colored layers already dried).

CAST-CURING: Texturing technique that involves the application of a transparent textured film (release film) onto the surface of a liquid formulation (in the context of the present invention, a photocurable formulation containing at least one thermoplastic resin). The formulation is then photopolymerized (cured) while in intimate contact with said textured transparent film. Subsequently, the textured transparent film is removed, faithfully transferring its three-dimensional structure and surface characteristics (including gloss variations) to the cured formulation. The specific composition of the embossable formulation (with thermoplastic resin) allows for high fidelity replication, including variable gloss reproduction, and drastically reduces volumetric shrinkage and “polymer relaxation” of the texture.

MECHANICAL EMBOSSING: Texturing technique that involves the application of pressure and/or heat to an already photopolymerized/cured formulation by using an embossing element (e.g., mold, press, engraved cylinder) to create a permanent three-dimensional structure on the surface. In the context of the present invention, the combination of mechanical embossing with a photocurable formulation containing a thermoplastic resin reduces the risk of breakage or loss of structure (polymer relaxation) typical of traditional formulations, even with high loads of anti-abrasive fillers.

DIGITAL EMBOSSING (Additive/Selective Texturing): Texturing techniques that use digital printing systems (e.g., inkjet) to create a three-dimensional structure on the surface of a formulation. This can occur through:
Additive Texturing: Controlled deposition of successive layers of photocurable liquid to build a three-dimensional relief.
Selective Texturing (Inhibition/Removal): Digital printing of texturing fluids (e.g., polymerization inhibitors) on specific areas of a liquid or partially polymerized embossable formulation, selectively altering its properties to allow the creation or release of the texture in those areas through subsequent mechanical processes (e.g., brushing).

EMBOSSABLE LAYER (EMBOSSABLE FORMULATION: A fluid composition, typically photocurable and containing at least one thermoplastic resin, specifically designed to be applied on a surface and subsequently shaped to create and maintain a permanent three-dimensional structure (embossing) after curing. Such embossing can be achieved by various techniques, such as mechanical embossing, cast-curing, or digital embossing, imparting flexibility, resistance, and distinctive aesthetic properties to the surface.

### SUMMARY OF THE INVENTION

The method of the invention overcomes the limitation of direct-to-board technology (direct printing) by allowing decoration in single plank and at the same time the use of offline lamination lines with digitally printed film. The method object of the invention involves printing an image on a flexible film, applying on it an embossable layer (consisting of a photocrosslinkable formulation containing at least one thermoplastic resin) and photopolymerizing/hardening it; embossing the film; and applying an adhesive (consisting of a photocrosslinkable formulation containing at least one thermoplastic resin) on the side opposite to where the embossable layer was applied and pre-photopolymerizing it. The film thus obtained is then laminated, from the adhesive side, to the substrate to be decorated.

The method object of the invention involves the use of hybrid systems with thermoplastic properties, in particular the use of photocrosslinkable resins in combination with non-photocrosslinkable thermoplastic resins. Such hybrid systems can also constitute the basis for one or more layers of the decoration cycle, such as: adhesion primer, white base, ink, printing primer, finish and adhesive. Non-limiting examples of the formulations of such hybrid systems can be those described in WO2022034546A1.

In accordance with a further aspect of the invention, the method object of the invention uses embossing technologies, both analog and digital, for example texturization by means of inkjet texturizing fluids. This technology is well described in WO2020039361A and WO201806987A1.

In accordance with a further aspect of the invention, the method object of the invention uses adhesives consisting of a photocrosslinkable formulation in which a thermoplastic resin has been dissolved. The adhesive object of the invention is first photopolymerized and does not present blocking characteristics, to then be reactivated by heat in a subsequent stage, such as during the lamination of the decorative film to the material to be decorated. This type of adhesive is extremely useful as it combines the easy handling of UV formulations (cleaning, photopolymerization speed) with the ability to be activated by heat application. U.S. Pat. No. 6,210,517B1 provides for the use of adhesives consisting of a photocrosslinkable formulation in which a thermoplastic resin has been dissolved. U.S. Pat. No. 11,518,895B2 instead provides an inkjet adhesive consisting of a photocrosslinkable formulation in which a thermoplastic resin has been dissolved. These types of adhesive, while presenting adhesive characteristics, are totally/partially reversible with increasing temperature with consequent potential delamination of laminated materials. The adhesive object of the invention can also crosslink through secondary reactions (dual-cure), thus conferring additional structural characteristics.

### BRIEF DESCRIPTION OF THE DRAWINGS

FIG. 1 illustrates a schematic reproduction of the process of the invention and, for completeness, a possible configuration of the machinery for implementing such method. In this case the method is performed with inkjet printing and photocrosslinkable coatings, there is also a station to apply the adhesive on the non-printed side of the flexible film. FIG. 1 shows: an unwinder (1.1), an accumulator (1.2), a tensioner (1.3), a central drum (1.4), a surface treatment (optional) (1.5), color inkjet printing (1.6), pinning (1.7), application of the embossable layer (1.8), application of the finishing coating (1.9), photopolymerization (1.10), application of adhesive on the non-decorated side (optional) (1.12), and a rewinder (1.11).

FIG. 2 illustrates the detail of mechanical embossing, showing: substrate to be decorated (2.1), flexible film (2.2), embossable layer (2.3), finishing coating (2.4), embossing cylinder (2.5), and laminated and embossed surface (2.6).

FIG. 3 illustrates the detail of cast-curing with release film used continuously: release film unwinder (3.1), film tensioning system (3.2), UV Hg lamp for curing through the film (3.3), and release film rewinder (3.4).

FIG. 4 illustrates the structure of the ready-to-laminate film, indicating the adhesive (4.1), the flexible film (4.2), the digital printing (4.3) and the embossed paint (4.5).

FIG. 5 illustrates the application of the ready-to-laminate film in line with core extrusion: extruder (5.1), calenders (5.2), embossing element (5.3), core (5.4), decorated and embossed core (5.5), ready-to-laminate film with adhesive (5.6).

FIG. 6 illustrates the application of the ready-to-laminate film offline on the substrate to be decorated: substrate to be decorated (6.1), decorated and embossed substrate (6.2), ready-to-laminate film with adhesive (6.3), application of the adhesive containing at least one thermoplastic resin (6.4), photopolymerization of the adhesive (6.5), reactivation of the adhesive by heat (6.6), lamination (6.7).

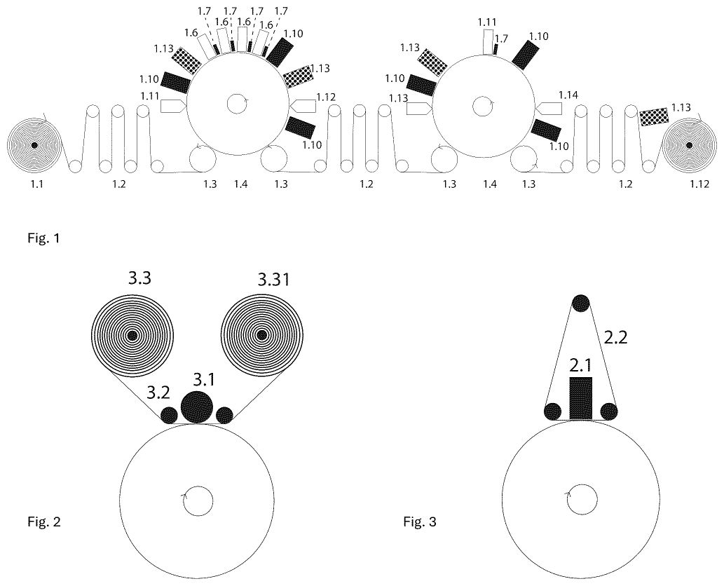

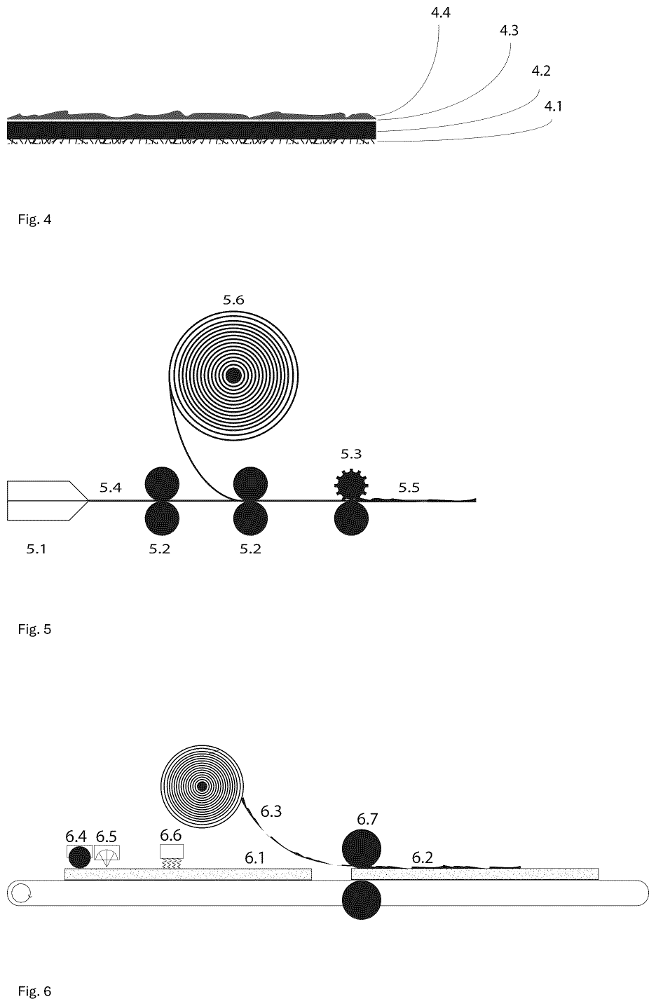

### DETAILED DESCRIPTION OF THE INVENTION

The applicant has found a method for decorating a material, object of the present invention, comprises the following phases:

### I. Preparation Phases of the Ready-to-Laminate Film

Printing and Initial Photopolymerization: Print an image or uniform color on at least part of a flexible film and photopolymerize/dry the ink.

Preparation and Embossing of the Embossable layer: Apply an embossable layer, consisting of a photocrosslinkable formulation containing at least one thermoplastic resin, to at least part of the flexible film.

For Mechanical Embossing (on polymerized embossable layer): The embossable layer is photopolymerized/dried before embossing. The embossing is then performed mechanically on the film, particularly on the already polymerized embossable layer layer.

For Cast-Curing (with liquid formulation and simultaneous curing): The embossable layer is kept liquid after application. A textured release film is applied to the surface of the liquid embossable layer and photopolymerization of the formulation occurs while in contact with said release film, with subsequent removal of the release film to transfer the texture.

For Digital Embossing (with selectively released texture areas): The embossable layer, still liquid or partially polymerized, receives a digital print of specific areas where subsequently the texture will be released/created. Photopolymerization of the embossable layer occurs after this digital printing.

Application and Pre-photopolymerization of the Adhesive: Apply an adhesive, consisting of a photocrosslinkable formulation containing at least one thermoplastic resin, on the side of the flexible film opposite to where the embossable layer was applied and pre-photopolymerize it.

II. Lamination and Finishing Phases of the Substrate Decorated with Ready-to-Laminate Film

Lamination of Film to Substrate: Laminate the decorated flexible film, coated with the embossable layer and with the adhesive applied on the opposite side, on at least part of a substrate to be decorated, by using heat and/or pressure.

Finishing of Laminated Substrate (for Digital Embossing): In the specific case of digital embossing applied on the ready-to-laminate film, this phase includes brushing of the laminated substrate to free the digitally created texture and, optionally, the application of a finishing coating.

### III. Materials Composing the System

### A. Substrate to be Decorated

Depending on the application (e.g., flooring, furniture, bathroom covering, wall covering), the substrate can be composed of different materials such as wood and derivatives (MDF/HDF/Particleboard/OSB), polymers such as PVC and derivatives (SPC/LVT/WPC), polyolefins (PP, PE), polyesters, inorganic materials (calcium silicate, MgO), metals and their combinations. The raw materials can be virgin as well as totally or partially recycled. To reduce weight, the substrate could be expanded/foamed. The expansion could be performed using an expanding agent such as ADC (azodicarbonamide), rather than the use of a gas such as nitrogen. The thickness of the support to be decorated depends on the application and for example for floors it is typically 3-8 mm while for furniture it is 15-30 mm.

### B. Flexible Film

The flexible film is chosen based on the application, and can be paper and derivatives, normally used for decorating wood or wood derivative supports; polymeric films such as PE, PP (BOPP, CPP), PET, ABS, PVC; metals such as aluminum and their combinations. Thicknesses are generally <1 mm, typically between 30 u and 150 u. For example, in the case of vinyl floors (SPC/LVT) a white PVC film with thickness 70-90μ is normally used. Alternatively, to produce PVC-free floors, PP films (CPP or BOPP) or polyester are used. To maximize floor recyclability, the decorative film and substrate are of the same chemical nature, for example the BOPP/CPP film is laminated to the substrate composed of PP+fillers, similarly the PET film is laminated to the substrate composed of PET+fillers.

### C. Adhesive on Film

In a preferred form of the invention, the decorated film coated with the embossable layer object of the invention has an adhesive side. The adhesive provided on said adhesive side can be of the thermo-reactivatable type and/or of the so-called self-adhesive type (PSA). The use of PSA could be interesting for DIY decoration and could be used as an alternative to wallpaper or to cover existing floors.

### IV. Embossing Technologies and Problems Solved

Unlike melamine surfaces (laminates), to date, for vinyl floors (SPC/LVT) it is not possible to generate surfaces with different gloss/brightness through pressing. In fact, although PVC, given its thermoplastic characteristics, can generate glossy/matte surfaces with dedicated embossing elements, for practical purposes the application of the topcoat, necessary to ensure scratch and stain resistance, uniformizes the surface creating a uniform gloss.

A first aspect of the invention is the realization of a decorated and coated film that can be mechanically embossed, for example, by static pressing, continuous pressing (for example double-belt presses), engraved cylinders. In the case of discontinuous pressing, mechanical embossing involves the use of embossing elements such as molds, while in continuous pressing double-belt presses are normally used (produced for example by HYMMEN DE with metal belt, ex-MEYER DE with synthetic material belt) in which the belt embossing element is engraved or an additional embossing element such as an embossing paper or film (e.g. SAPPI, SURTECO embossing films/papers) is applied between the belt and the substrate to be embossed; alternatively for continuous pressing, engraved cylinders could be used. The embossing elements can reproduce complex structures with different depths, different thicknesses and variations in gloss/brightness. In all respects, the structures generated by pressing can present aesthetic characteristics and details superior to those of natural materials. The applied pressure depends on the substrate to be decorated, the type of embossing element used and the desired surface technical characteristics and can generally be between 0.5 and 10 Kg/cm2. In fact, similarly to melamine laminates, pressure improves heat transmission, acceleration of secondary reactions (dual-cure) and surface chemical-physical properties. In particular, although 0.5 Kg/cm2 is sufficient to obtain good embossing with glossy/matte effects, increasing the pressure to 1.5 Kg/cm2 results in surfaces with more detailed textures and superior chemical-physical characteristics.

According to an embodiment that can be provided alternatively or in combination with one or more of the other embodiments provided it is not technically contradictory, the embossing element is heated, preferably between 40 and 220° C., the temperature being a function of the composition, Tg and/or softening point of the polymerized/solidified embossable layer. Alternatively, the embossing element is not heated but the photocrosslinkable polymerized formulation is heated before the embossing phase.

According to an embodiment that can be provided alternatively or in combination with one or more of the other embodiments provided it is not technically contradictory, the embossable layer is heated to or above its Tg and the embossing element is cooled below the Tg of the embossable layer. In this way the structure is “frozen” increasing its definition and/or depth. According to a preferred embodiment of the invention, the embossable layer is heated and subsequently cooled while always maintaining contact with the embossing element. Advantageously for this purpose a double-belt press (double-belt laminator) characterized by having a hot zone followed by a cold zone is used. Alternatively the process could be discontinuous, using static presses heated and subsequently cooled in a manner similar to those used for melamine laminate production.

In a preferred form of the invention, the ready-to-laminate film is applied after core extrusion of the core, normally of polymeric nature, when the temperature has dropped but is sufficient to activate the adhesive applied on the back of the ready-to-laminate film. At this point the ready-to-laminate film and the embossing paper are applied simultaneously (or also in succession) and everything is pressed and cooled in the double-belt press.

According to an embodiment that can be provided alternatively or in combination with one or more of the other embodiments provided it is not technically contradictory, embossing occurs without the need to heat the embossing element and/or the embossable layer by exploiting the plastic deformation of the embossable layer. Normally plastic deformation alone is not usable for embossing photocrosslinkable formulations since the risk of partial or total structure loss due to polymer relaxation is high. On the other hand, the thermoplastic characteristics of the formulation object of the invention allow its use without structure losses.

According to an embodiment that can be provided alternatively or in combination with one or more of the other embodiments provided it is not technically contradictory, the substrate to be decorated is preheated before laminating the decorated film coated with the embossable layer object of the invention. For example, in the case of SPC, the substrate can be laminated after the extrusion phase while it is still hot. Preheating facilitates the lamination of the decorated and coated film with the embossable layer object of the invention.

According to an embodiment that can be provided alternatively or in combination with one or more of the other embodiments provided it is not technically contradictory, embossing is achieved by using an embossing element heated and subsequently cooled. In this way the aesthetic reproduction of the embossing element is best exploited and in particular the creation of surfaces with different gloss and/or roughness. Preferably this method is performed using double-belt presses in which heat and/or cooling are applied to one or both pressing sides. The embossing element is preferably made of embossing papers that allow rapid changing of the embossing type and are reused many times (10-30 times or more) reducing costs and increasing sustainability. The embossing paper can be used either by unwinding and then rewinding the reel or in a closed loop; obviously, in the case of reel-to-reel, the advantage could be having fewer repetitions of the structure to be reproduced, while the closed loop would have the advantage of avoiding line stoppage for reel change.

According to an embodiment that can be provided alternatively or in combination with one or more of the other embodiments provided it is not technically contradictory, the flexible film to be decorated is colored in the mass or coated on the surface. In fact, to reduce the quantity of printed ink and/or improve the quality of the image the flexible film could be colored, for example, in the case of wood reproduction it could be a light brown background. A limitation of inkjet printing is the ability to generate solid colors free from aesthetic defects. In fact, the solid colors generated by an inkjet system normally show non-uniformity of color due to different densities of the same. In addition to this problem, inkjet printing is characterized by missing nozzles, i.e. nozzles that do not shoot the ink correctly, producing white lines, particularly visible in solid colors. Advantageously the color can be produced on demand by mixing specific colors in line using a continuous mixer like a static mixer, controlled by a flowmeter and applied by means of a slot-die. Preferably the mixer is of static type, lamellar mixer (Sulzer SMX), Ross LPD mixer, Komax mixer, Kenics static mixer, FixMix mixer. Preferably the colors have low viscosity to case mixing. Advantageously the colors might be the same used for the inkjet printing (Cyan, Magenta, Red, Yellow, Black and/or their light version) or dedicated colors might be selected to achieve the desired gamut (Orange, Violet, Green).

According to an embodiment that can be provided alternatively or in combination with one or more of the other embodiments provided it is not technically contradictory, the base color applied on the film is generated by overlapping one or more colored layers. To maximize the overlapping effect, the colors are preferably transparent and obviously the more colors are being used, the greater the gamut that can be obtained. Again, because of then high transparency (submicronic pigment particle size) inkjet colors are ideal for these applications. Similarly, by varying the quantity of colored paint applied, different color densities will be obtained and a further extended gamut will result. Preferably the colored layers are first dried/polymerized and subsequently overlapped. In another form of the invention the colored layers can be overlapped before their drying/polymerization. This overlapping technology, called overprinting, is well described in the book “Color by overprinting; A complete guidebook in the art and printing techniques employing transparent inks in multiple combinations—Jan. 1, 1955”.

According to an embodiment that can be provided alternatively or in combination with one or more of the other embodiments provided it is not technically contradictory, the color application of the above-mentioned embodiments might be controlled by an in-line color measurement system, such as a spectral camera and/or a color image sensor (CIS). Based on the measured value, the applied color amount and/or color mix might be accordingly tuned.

According to an embodiment that can be provided alternatively or in combination with one or more of the other embodiments provided it is not technically contradictory, the decoration could be carried out on the unprinted side of an already decorated film. This methodology could be useful for recovering films that are no longer usable, reducing waste and warehouse stocks.

### V. Formulations Used in the Method

In a preferred embodiment of the invention, the printing ink, the embossable layer, the finishing paint, the adhesive, the printing primer and more generally the liquid layers that compose the method object of the invention are of photo-crosslinkable nature. Photo-crosslinkable resins or rather, energy-curable resins have in common the fact that they polymerize and harden thanks to the energy radiated by ultraviolet ray devices and/or by EB (Electron Beam) irradiation and they are divided into two types based on the cross-linking mechanism:
1. RADICALIC, typically made of vinyl monomers and acrylate resins which are divided in different subcategories, including: epoxy-acrylate, urethane-acrylate, polyester-acrylate, polyether-acrylate, amino-acrylate, silicon-acrylate, polyisoprene-acrylate, polybutadiene acrylate and acrylate monomers. Among the vinyl monomers we can mention N-vinylcaprolactam (NVC), acryloylmorpholine (ACMO), diethylene glycol divinyl ether (DVE-2), triethylene glycol divinyl ether (DVE-3) and their mixtures. The term acrylate refers to both acrylate and methacrylate resins.
2. CATIONIC, such as epoxy resins, polyols and monomers such as oxetanes and vinyl ethers. The photo-crosslinking technology is well described in the book “Radiation Curing: Science and Technology” (Pappas).

In another preferred embodiment, formulations based on dispersed and/or dissolved thermoplastic resins capable of forming a film while maintaining thermoplastic properties after the removal of the solvent or dispersion vehicle could be used. For example, acrylic resins dissolved in an appropriate solvent could be used. Among the various usable acrylic resins we can cite Degalan (EVONIK), Elvacite (LUCITE), Joncryl (BASF), Neocryl (COVESTRO), Paraloid (DOW).

In a further preferred embodiment of the invention, the embossable layer consists of a photo-crosslinkable resin in which a thermoplastic resin is dissolved and/or dispersed. Typically, the thermoplastic resin is used dissolved in the photo-crosslinkable resin between 1% and its solubility limit which is a function of the chemical nature of the resin and its molecular weight. In another form of the invention, the thermoplastic resin is not dissolved in the photo-crosslinkable resin but is dispersed therein.

The thermoplastic resins that could be used in combination with photo-crosslinkable systems, for example one or more of the above disclosed examples of photo-crosslinkable resins or systems can be part but not limited of the following type: acrylonitrile butadiene styrene (ABS), polyvinyl chloride (PVC), ethylene vinyl acetate copolymer (EVA), polylactic acid (PLA), polyamide (PA), polybenzimidazole (PBI), polycarbonate (PC), polyethersulfone PES (U), polyethylene (PE),polyethylene terephthalate (PET), polymethyl methacrylate (PMMA), polyoxymethylene (POM), polypropylene (PP),polystyrene or polystyrene (PS), polytetrafluoroethylene (PTFE), thermoplastic polyurethanes (TPU), polyvinyl acetate (PVAC), thermoplastic acrylic resins, SBS resins, SEBS resins, SEEPS resins, SEPS resins, SIS resins and/or mixtures and/or copolymers of the previous ones.

Thermoplastic resins are normally characterized by:
Appearance, for example granules, powder, tablets, flakes.
Glass transition temperature Tg and softening point, useful to understand at which temperature the resin assumes viscous behavior.
Molecular weight, useful for understanding the solubility in the photo-crosslinkable formulation.
Fluidity of the molten resin.
Acidity number, useful for understanding compatibility/incompatibility with other chemical species.
Viscosity of the melt or in solution.
Functionalizations, such as the presence of amino, carboxylic, maleic, hydroxyl groups, isocyanates capable of reacting in primary or secondary reactions.

According to a further characteristic, the thermoplastic resins listed above might be functionalized with various chemical groups such as maleic, hydroxyl, carboxyl, amino, isocyanate, glycidyl groups. These groups can participate in secondary reactions (dual-cure) useful for improving the performance of the system itself. For example, the hydroxyl group can react with a-CNO group to form a urethane bond, while the —COOH group can react with TGIC (triglycidyl isocyanurate), triglycidyl methacrylate or with amino and/or hydroxyl groups. In addition to participating in secondary reactions,functional groups could facilitate the dispersion of pigments and fillers such as aluminum oxide and ceramic microspheres. The same type of thermoplastic resins can be used for the embossable layer solvent-based while for the water-based dispersions polyurethane and/or acrylic resins can be used.

According to an embodiment that can be provided alternatively or in combination with one or more of the other embodiments provided it is not technically contradictory, the embossable layer object of the method of the invention comprises one or more photo-crosslinkable resins, photoinitiators, one or more thermoplastic resins and it might optionally contain one or more of the following additives such as one or more fillers, such as aluminum oxide (corundum) to increase the abrasion resistance, talc to modify the rheology, silica to reduce the gloss, calcium carbonate as a filling filler, pigments to impart color, additives such as leveling, wetting, slipping, rheology modifying agents and in general additives and components commonly used in coatings for wood and/or flooring.

According to an embodiment that can be provided alternatively or in combination with one or more of the other embodiments provided it is not technically contradictory, the embossable layer object of the method of the invention might contain further components non-photo-crosslinkable and/or non-thermoplastic such as epoxy, polyurethane and acrylic resins. Such non-photo-crosslinkable and/or non-thermoplastic systems might be used to modify the rheological characteristics (e.g. viscosity, thixotropy) and/or the chemical-physical characteristics (e.g. hardness, flexibility, scratch resistance, abrasion resistance and/or the possibility of secondary reactions occurring (dual-cure).

According to an embodiment that can be provided alternatively or in combination with one or more of the other embodiments provided it is not technically contradictory, between the various layers applied such as the printing ink, the embossable layer, the finishing paint, the printing primer layer and more generally the layers making up the method, which is the object of the invention and disclosed according to the preceding embodiments, a chemical reaction occurs. For example, one layer may contain isocyanate groups and the next and/or previous adjacent layer may contain hydroxyl groups forming a urethane-type bond between the said two adjacent layers.

| PROCESS | FUNCTIONAL GROUPS |
|---|---|
| DUAL-CURE Isocyanate-alcohol or water | 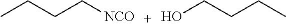 |
| Melamine-alcohol | |
| THERMAL Epoxy-acid Epoxy-amine Cationic UV | 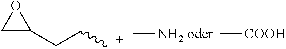 |
| (epoxy) | |
| THERMAL | |
| CROSS- | |
| LINKING | |
| OF ACRYLATES | |
| Peroxides, | |
| TRI (thermal | |
| Radicalic initiator). | |
| OXIDATIVE DRYING | 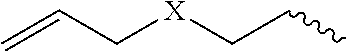 |
| CURING WITH HUMIDITY | 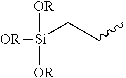 |

The most common method is the combination of photopolymerization by radiation with thermal crosslinking. Thermal crosslinking methods are available in many variants. There are numerous possible combinations of radiation hardening with thermal hardening, such as the common reaction of the hydroxyl group (e.g. SR 444D, CN 7672) containing unsaturated acrylic esters with isocyanic resins (e.g. LAROMER 9000, EBECRYL 4141, EBECRYL 4397 EBECRYL 4155, EBECRYL 4250) or melamine cross-linkers (e.g. CYMEL). These OH group-containing acrylates can be applied in two-component systems in combination with polyisocyanates or as one-component coatings in combination with melamine resins, so that following radiation and thermal crosslinking, a homogeneous network of radically polymerized acrylates and thermally cross-linked groups results.

Other applicable systems can be based on epoxy groups introduced into acrylic esters, so that induced cationic epoxy curing occurs via thermal latent acid donors as a UV light-independent mechanism, or the epoxy acrylates can be cross-linked with carboxylic acid or amino group-containing resins. Other possibilities are the combination of acrylates with oxidative drying groups, which polymerize slowly with oxygen analogous to alkyd resins. Alternatively, photo-crosslinkable aqueous dispersions often exhibit physical drying without irradiation. Polyurethane dispersion resins, for example, have a much higher molecular weight than traditional 100% UV resins and can be designed to provide glass transition temperatures of uncured coatings above room temperature. They can be cross-linked in areas of use by radiation hardening to deliver the designated performance spectrum and solidified in shadow areas, where often the requirements are only related to low emissions, low migration and low odor. A further photopolymerization mechanism is photopolymerization with humidity. Humidity hardeners are, for example, siloxane or isocyanate groups. Compounds containing both unsaturated acrylates and siloxanes or free isocyanate groups are commercially available. A particularly useful polymer having free isocyanate and unsaturated acrylic ester functions (Laromer LR 9000) has recently been introduced. This molecule can be used as a polyisocyanate component in the formulation of UV-polymerizable 2K systems in combination with hydroxyl-containing resins, or as a sole binder resin using moisture curing of the isocyanate groups, and as a primer resin, where the isocyanate groups react with the functional groups of the substrate. For example, the reaction between the NCO groups of the resin and their respective reaction partners in the substrate (OH—, HOOC—, etc.) results in excellent adhesion to the substrate.

A further possibility of Dual Cure systems is the thermal photopolymerization of unsaturated acrylate groups using peroxides, benzpinacol (tetraphenyl ethanediol) or other thermally latent Radicalic formers (TRIS). In these formulations both radiation-induced and thermally induced photopolymerization use the same functional groups and therefore, at least theoretically, should provide the same network. In an executive embodiment of the invention, locked reactive systems are used which are then unlocked on command by a certain event, such as reaching a certain temperature. Blocked isocyanates are part of this product category. Alternatively, melamine resins can be used which are stable at room temperature and which are activated at high temperatures, typically >100° C. In addition to temperature, secondary reactions could be activated by UV irradiation. For example, PAGs (photo acid generator), capable of generating acids usable as catalysts for secondary reactions, could be used. In addition to PAGs, PBGs (photo basic generator) could be exploited which, contrary to PAGs, release basic species such as amines during irradiation. Cationic photoinitiators can also be used for this purpose, as they release acids upon irradiation. In order to guarantee the mobility necessary for secondary reactions to occur, it may be useful to partially polymerize the system, then reach the temperature necessary for the secondary reaction to occur and subsequently complete the photopolymerization by further irradiation. Partial polymerization could be performed using traditional arc lamps or better using LED lamps which could be more effective thanks to monochromatic emission. Alternatively, the secondary reaction could occur before photopolymerization.

Polymer relaxation is a characteristic of polymeric systems whereby a stretched or deformed polymer chain gradually returns to its equilibrium state, following the removal of a mechanical, thermal, or chemical stress. This behavior is typically described in terms of viscoelastic relaxation and depends on molecular mobility and temperature. In practice, the embossed polymer tends to “flatten” over time and with temperature; even just >60° C. has a great influence on it. The thermoplastic resin used in the photocrosslinkable formulation contributes significantly to maintaining the embossing, drastically reducing polymer relaxation. In this regard, the thermoplastic resin is chosen based on its Tg, generally better higher, and molecular weight, also in this case better higher. Below are the measured values of structure loss due to polymer relaxation for different formulations. The loss of structure is measured as Rt (the vertical distance between the highest point of the profile and the lowest point, within the evaluation section considered) before and after heating.

| | Mechanical embossing | | | Cast-cure embossing | | |
|---|---|---|---|---|---|---|
| | | Rt | Rt | | Rt | Rt |
| Formulation | Rt | 1 h@80° C. | variation | Rt | 12 h60° C. | variation |
| A | 42.3 | 38.1 | −9.9% | 54.2 | 51.5 | −5% |
| object of the invention | | | | | | |
| B | 36.8 | 34.9 | −5% | 62.3 | 58.3 | −6.4% |
| object of the invention | | | | | | |
| Industrial UV coating with | 26.9 | 1.3 | −95% | 58.7 | 40.2 | −31.5% |
| Al₂O₃ | | | | | | |

From the values in the table it is evident how the presence of thermoplastic resin is able to drastically reduce structure loss at 60° C. and 80° C.

According to an embodiment that can be provided alternatively or in combination with one or more of the other embodiments provided it is not technically contradictory, the embossable layer does not contain any thermoplastic resin but is a photo-crosslinkable formulation with dual-cure mechanism. In fact, the use of dual-photopolymerization systems would help minimize polymer relaxation and maintain the mechanically embossed structure.

Furthermore, the embossed formulation object of the invention possesses plasticity and/or elasticity characteristics capable of limiting the core deformation effect already mentioned previously. This deformation defined as (bending/curling/cupping) is due to the volumetric shrinkage of photocrosslinkable formulations after photopolymerization and is accentuated by heat. The deformation can be both longitudinal and transverse and in addition to heat it is accentuated by the amount of photocrosslinkable formulation applied. On the other hand, the high flooring specifications imply a large amount of applied coating which only worsens this phenomenon.

According to an embodiment that can be provided alternatively or in combination with one or more of the other embodiments provided it is not technically contradictory, between the film decorated and coated with the embossable layer object of the invention and the substrate to be decorated, an adhesive is applied. This adhesive could be in liquid form, such as solvent-based or water-based acrylic, vinyl, SBR-based or hot-melt type. These types of adhesives are normally applied to one or both materials to be bonded shortly before lamination. Alternatively, the adhesive is in solid form, an adhesive film commonly called a tie-layer. The use of adhesive film could have multiple reasons such as, for example, lowering the lamination temperature and/or making the layers to be laminated compatible with each other that would otherwise be difficult to laminate. Examples of tie-layers are adhesive films marketed by Collano (CH) or BEMIS (US). A further type of adhesive could be a self-adhesive (PSA-pressure sensitive adhesive) which has the advantage of being able to be applied at different times after application. For specific applications the adhesive may be applied to both materials to be coupled and different types of adhesives may be used in combination with each other.

In a preferred form of the invention, the adhesive consists of a photocrosslinkable formulation in which a thermoplastic resin is dissolved. As already described, the thermoplastic resin dissolved in the photocrosslinkable resin imparts thermoplastic properties to the system and consequently under certain temperature conditions can assume adhesive characteristics. Preferably, the adhesive consists of a photocrosslinkable monomer capable of dissolving the thermoplastic resin whose content can vary from 1% to the solubility limit of the resin. Generally the resin is solubilized between 10% and 40%. In this way, by varying the chemical nature of the thermoplastic resin and/or its specifications (Tg, molecular weight, functionalization) it is possible to modulate the adhesion strength, affinity towards materials to be laminated and more generally the properties of the adhesive. The monomer is chosen based on the material to be laminated, choosing monomers/photocrosslinkable resins with affinity to the materials to be laminated. For example, adhesives for PVC will preferably contain HDDA rather than THEA while for PP IBOA and/or EOEOEA will be used. Similarly to other layers forming part of the ready-to-laminate film, the adhesive could undergo secondary crosslinking (dual-cure) which confers structural properties to the adhesive. For this purpose, the adhesive will contain species capable of participating in secondary reactions in addition to those of photocrosslinking. The dual-cure mechanism is extensively described in this application.

According to an embodiment that can be provided alternatively or in combination with one or more of the other embodiments provided it is not technically contradictory, embossing takes place using successive applications of two or more embossing elements. In a further embodiment of the invention, the embossing occurs in register with the underlying image. This is made possible with the use of embossing elements specifically dedicated to each type of printed image. Moreover, to achieve better EIR combination of printed references and optical systems as cameras might be used. In a preferred embodiment of the invention, the references for registration are invisible to the naked eye, for example they could be printed with inks containing dyes visible with UV cameras, or specific pigments detected by NIR cameras. Alternatively, the notable point for registration could be made by printing a hidden reference in the graphic itself, for example a geometric shape not visible to the naked eye but detectable by a system specially trained for this purpose.

According to an embodiment that can be provided alternatively or in combination with one or more of the other embodiments provided it is not technically contradictory, the embossing extends to the substrate to be decorated, i.e. the substrate is also embossed, thus maximizing the depth of the texture generated. To this end, intermediate layers, even undecorated, could be applied to the surface of the substrate, with the sole function of increasing the thickness of the embossed layer or making embossing easier. To maximize embossing, the applied layers could have different densities. For example, in the case of PVC floors, a plasticized PVC film (100-200μ), like a traditional wear layer in PVC, could be applied to a dense substrate (4-6 mm).

The embossing layer could be applied before or after printing. In the case of application before printing, it could be applied by means of heat and/or pressure or co-extruded in the substrate production phase. While in the case of application over printing, the material must be transparent and an adhesive could be used. The adhesive could be, similarly to the lamination of the decorated film on the substrate to be decorated, in liquid form, such as solvent-based or water-based acrylic, vinyl, SBR-based or hot-melt type. Surprisingly, the adhesive already described above, consisting of a photocrosslinkable resin in which a thermoplastic resin has been dissolved, can be used in a different mode. The adhesive is preferably applied to one of the 2 materials to be coupled, subsequently it is laminated to the support and then photopolymerized by irradiation from the side of the transparent material.

According to an embodiment that can be provided alternatively or in combination with one or more of the other embodiments provided it is not technically contradictory, the embossing element, which might be flexible (e.g. embossing paper, embossing film) or rigid (e.g. press plate, metal belt, calender), continuous or discontinuous, is texturized by digital technology and preferably by inkjet. Typically, the creation of relief elements with digital technology involves the overlapping of successive layers of photo-crosslinkable resins, after polymerization/gelling of each single layer. In this way embossing element can be produced just in time, obtaining the flexibility necessary for the decoration method which is the object of the invention. The digitally printed embossing elements might be printed on flexible materials, such as plastic films or paper or on rigid materials such as metals.

According to an embodiment that can be provided alternatively or in combination with one or more of the other embodiments provided it is not technically contradictory, in the case of mechanical embossing, the photocrosslinkable embossed formulation is fully cured before being embossed. This avoids detachment from the substrate due to poor adhesion and prevents the photocrosslinkable embossable layer from sticking to the embossing element. Optionally, after embossing, the photocrosslinkable embossable layer could be irradiated again to complete the polymerization and increase its mechanical properties.

According to a preferred embodiment of the invention, the decorated film coated with the embossable layer is embossed before lamination. Once embossed the film can be rewound and subsequently laminated. For example, the ready-to-laminate embossed film can be used to cover profiles such as skirting boards and door profiles. For example, profile wrapping lines are produced by Barberan(ES) and CEFLA (IT). The ready-to-laminate embossed film is generally laminated to the profile using rollers, with the aid of hot-melt adhesive or alternatively with water or solvent-based adhesives. In addition to profiles, the ready-to-laminate embossed film can be used to decorate panels.

In a further preferred form of the invention, the texturization of the embossable layer is of the digital type and involves localized applications, defined by digital templates, of texturizing liquid on the surface of the formulation which is the object of the invention. The texturizing liquid is capable of deforming in a controlled manner and/or modifying the chemical-physical characteristics of the embossed formulation in the areas to which it is applied, such as selectively inhibiting the polymerization of the photocrosslinkable embossable layer. Examples of these technologies will be better described below and already reported in patent applications WO2018069874Al and WO2020039361Al. After the application of the texturizing liquid, to prevent the texturizing liquid from soiling the back of the film once rewound, a protective layer is applied on the surface of the embossable layer on which the texturizing liquid has been applied. The protective layer can be made up of a coating, preferably photo-crosslinkable, and is applied at low weights, typically 4-6 g/m2. The coated film with the embossable layer on which the texturizing liquid has been applied is laminated to the support to be decorated and subsequently the texture such as the texturing liquid and/or a combination of texturing liquid and part of the embossable layer is released by mechanical action. The protective layer can be applied using both analogue and digital technologies.

In another preferred form of the invention, the embossing of the embossable layer occurs via “cast curing”. This approach is based on the application of a transparent textured film (release film) on the surface of a liquid formulation (in the context of the present invention, a photocrosslinkable formulation containing at least one thermoplastic resin). The formulation is then photopolymerized (hardened) while in close contact with said transparent textured film. Subsequently, the transparent textured film is removed, faithfully transferring its three-dimensional structure and surface characteristics (including gloss variations) to the hardened formulation. The concept of surface replication by photopolymerization of a coating in contact with a textured element (often defined as “cast curing”) is known from prior art, as described in patents dating back decades, for example U.S. Pat. No. 4,289,821 A. Such historical methods focused on the production of release sheets with high replication fidelity. More recent applications by special film manufacturers, such as those described in WO 2008/137400 A2 and U.S. Pat. No. 8,192,830 B2 while mentioning the extension of the concept to finished products such as flooring and coverings, do not fully address the challenges and and synergies inherent in modern high-performance coatings. Similarly, more recent patents, such as US 2017/0113248 A1 (Dohring et al., assigned to Kronoplus Tehnical AG), although they also describe methods of creating textured surfaces by applying a plastic material to wooden panels and subsequent structuring with a belt or textured roller before curing, focusing on direct panel coating, do not solve the specific problems of the present invention.

Unlike pre-existing “cast curing” solutions, the present invention distinguishes itself by the production of a flexible, high-performance, embossed ready-to-laminate film, which overcomes the limitations encountered in direct panel applications or in the production of only release films. This is made possible by applying the “cast curing” methodology to a specifically designed embossable layer. Such a formulation consists of a photocrosslinkable formulation that contains at least one thermoplastic resin. This unique composition imparts intrinsic flexibility, plasticity, and/or elasticity properties to the embossable layer, which are crucial for several fundamental reasons not solved by generic cast curing prior art and traditional formulations used in the flooring industry.

Firstly, the flexibility allowed by the thermoplastic resin enables the integration of high quantities (typically 10-30% by weight) of anti-abrasive fillers such as aluminum oxide (with dimensions greater than 50u), without the formulation becoming fragile or cracking after polymerization, as instead happens with traditional photocrosslinkable formulations and with high-performance products in the sector. This guarantees very high abrasion resistance (e.g. class AC5) and scratch resistance (e.g. B1).

Secondly, the combination of the thermoplastic resin with photopolymerization in “cast curing” drastically reduces both the volumetric shrinkage of the formulation, and consequently the deformation of the substrate (bending/curling/cupping), and the phenomenon of polymer relaxation (relaxation of the impressed texture). Traditional formulations suffer from significant texture losses and deformations (bending/curling/cupping) (e.g. 40-90% of “Texture Loss” at 60-80° C.), while the present invention allows obtaining a texture loss of less than 10% at 80° C. and a reduced bending (e.g. less than 0.7 mm). This intrinsic flexibility also eliminates the need to apply a backcoating to balance shrinkage.

Thirdly, photopolymerization in “cast curing” occurs in the absence or with reduced presence of oxygen (due to confinement between the textured transparent film and the flexible film or roller). This condition, combined with the properties of the embossable layer containing thermoplastic resin, allows for a high crosslinking density of the surface with consequent improvement of mechanical and chemical-physical properties. This allows obtaining products with high-performance glossy and matte areas without the need for an additional finishing layer (topcoat) for gloss control, which would usually uniformize the surface and reduce aesthetic options.

These synergistic advantages, deriving from the specific combination of a “cast curing” methodology applied to an intermediate film with an advanced embossable layer containing thermoplastic resin, clearly distinguish the present invention from more generic and older “cast curing” applications and offer solutions to persistent problems in the flooring and panel sector.

According to an embodiment that can be provided alternatively or in combination with one or more of the other embodiments provided it is not technically contradictory, texture creation occurs through controlled depositions of photocrosslinkable liquid (additive texturing). Preferably the application occurs using inkjet heads and, depending on the desired texture depth/thickness, it is possible to use multiple heads in series. Preferably after each application the photocrosslinkable liquid is (partially) photopolymerized. The heads in series could be printed using the same file or alternatively the files could be different to optimize the structure/definition of the texture. For example, the first row of heads could print the base of a “peak” and subsequent ones print successive parts overlapped to the base in a manner very similar to the logic of filament 3D printers. Additive texturization could also be used in combination with mechanical embossing or digital texturization or in combination with both.

In a preferred form of the invention, the photocrosslinkable embossed formulation is embossed both mechanically and digitally. In fact, digital embossing (as for example described in WO2020039361A1), although presenting countless advantages, presents some criticalities, especially when the areas to be removed are large. In fact, for large areas to be removed, both brushing problems occur due to the abundance of removed material and the simultaneous removal of material leads to a decrease in abrasion resistance due to a reduction in the quantity of anti-abrasive photocrosslinkable formulation. It is therefore particularly advantageous to use digital texturing technology in combination to create fine embossing and mechanical embossing for large embossing such as for example, the reproduction of planed and/or saw cuts. Obviously the digital texture will benefit from registration while the mechanical relief will not be registered; however, this does not represent a particular limitation as large embossings are often not made in registration.

According to an embodiment that can be provided alternatively or in combination with one or more of the other embodiments provided it is not technically contradictory, mechanical embossing, digital texturization and additive texturization are combined. Indeed, the combination of the three texture generation technologies could be useful to create and expand unique aesthetic and tactile effects.

According to an embodiment that can be provided alternatively or in combination with one or more of the other embodiments provided it is not technically contradictory, the flexible film to be decorated is pretreated before printing. The pretreatment can be chemical-physical, such as corona treatment, flame, plasma and/or by primer application. The pretreatment is useful both to ensure adhesion of subsequent layers to the film itself and/or to improve the printability of the film itself by optimizing the deposition and expansion of the ink droplet.

According to yet another embodiment that is provided in any combination or sub-combination with one or more of the previous embodiments, on the embossable layer it is possible to apply a further finishing layer, for example a layer capable of varying the brightness of the decorated support surface. The finishing layer can be applied both on the decorated film and on the decorated support on which the decorated film has been previously applied. In the case of mechanical embossing it is preferable to apply the finishing layer such as, for example, a finishing paint before embossing while in the case of digital texturization it is preferable to apply said finishing layer after mechanical removal of the texture as brushing could damage the finishing layer. According to the state of the art, the finishing layer is generally applied between 6 and 12 g/m2, in one or more passes. Generally, to confer the desired properties of scratch and stain resistance, the finishing layer is highly crosslinked/polymerized.

According to an embodiment that can be provided alternatively or in combination with one or more of the other embodiments as long as it is not technically contradictory, in the case of mechanical embossing and/or cast-curing embossing, the embossable layer object of the invention is embossed without applying the finishing layer on it, such as for example a topcoat. In this way it is possible to exploit the thermoplastic properties of the formulation to create glossy/matte effects on its surface. In fact, similarly to melamine surfaces, molds or more generally embossed elements can be used which, in addition to the main texture (such as wood grain), present matte and/or glossy areas. Given the thermoplastic characteristics of the embossed formulation object of the invention, after pressing both the texture and the glossy/matte areas present on the embossed element will be reproduced.

According to an embodiment that can be provided alternatively or in combination with one or more of the other embodiments as long as it is not technically contradictory, the embossable layer is applied in a single application in quantities that depend on the desired texture depth and/or required performance, such as abrasion resistance. The embossable layer could also confer the desired brightness, avoiding the subsequent application of the finishing layer. To confer low gloss (<10 GU at) 60°, the embossable layer preferably contains inorganic matting agents such as silica, aluminum oxide and/or organic matting agents such as micronized polymers (e.g. PP/PE/PA), waxes. In general, to obtain the desired brightness, state-of-the-art matting technologies could be used as described in “Low-gloss UV-curable coatings: Light mechanisms, formulations and processes-A review, 2022, ELSEVIER”.

According to an embodiment that can be provided alternatively or in combination with one or more of the other embodiments as long as it is not technically contradictory, the embossable layer is applied with a thickness equal to or greater than the size of any solid fillers present in the formulation. For example, if the formulation contains aluminum oxide with maximum size of 70u, the embossable layer must be applied with a thickness of at least 70u.

### VI. Machinery for Method Implementation

According to a preferred embodiment, the present invention provides a machine for printing and coating flexible substrates comprising one or more unwinding elements for advancing the material in coil to be decorated equipped with at least one traction drum (central drum) suitable for receiving, at an inlet zone, the film to be decorated and conveying it towards an outlet zone circumferentially spaced, along the direction of rotation of the traction drum around its own axis, from the inlet zone; around the traction drum (central drum), between the inlet zone and the outlet zone, analog coating stations and digital printing stations are arranged and transport means are provided to convey the film material to be decorated that arrives from the traction drum (central drum) along an advancement path that has at least one advancement portion of the film to be decorated that extends substantially rectilinear. The use of the central drum is very widespread in flexographic printing and has several advantages over the more common in-line and stack printing, such as:
Easy film tensioning.
Temperature control as the basket is thermoregulatable.
Easy print registration.
   For the application of non-digital layers, for example adhesive, primer, white base, embossed formulation, topcoat, common application technologies could be used such as roller coater, flexographic units, knife coater, gravure cylinder, rotary screen printing. In a preferred form of the invention, the application of non-digital layers and in particular the embossable layer is applied in a single application using a slot-die. The slot-die is a highly versatile tool for applying more or less viscous liquids since the amount of fluid applied can be defined by selecting the internal geometry of the manifold and/or the thickness of the shim and/or the lip geometry, as well as process adjustment such as fluid flow rate and/or distance from the substrate. The amount of material applied can be monitored using a flowmeter and/or mass meter. In this way, with the help of PLC (Programmable Logic Controller) or similar systems it is possible to create recipes based on desired product specifications. For example, the user could select a certain degree of abrasion resistance on the machine logic controller and the specific amount of coating would be applied accordingly.

According to an embodiment that can be provided alternatively or in combination with one or more of the other embodiments provided it is not technically contradictory, the flow of the various components of digital fluids and/or non-digital layers is monitored through the use of flowmeters that provide important information for both printing and maintenance. For example, printing requires that ink flow be constant and balanced between the various heads. Particularly efficient is the use of MEMS flow meters, such as, for example, those produced by SENSIRION which, in addition to reduced dimensions, also provide the precise value of the temperature of the monitored fluid.

According to an embodiment that can be provided alternatively or in combination with one or more of the other embodiments provided it is not technically contradictory, the embossable layer and topcoat are applied simultaneously using a 2-outlet slot-die (multilayer slot-die).

According to an embodiment that can be provided alternatively or in combination with one or more of the other embodiments provided it is not technically contradictory, the adhesive, primer, inks, embossable layer, finish (topcoat) and in general the various components of the decoration cycle are of photo-crosslinkable nature and polymerization occurs by irradiation with LED lamps. The use of LEDs, especially during printing, is ideal as LEDs do not emit as much heat as traditional arc lamps and in this way distortions of both the film itself and the machinery are reduced with consequent improvement in print quality.

According to an embodiment that can be provided alternatively or in combination with one or more of the other embodiments provided it is not technically contradictory, in addition to traditional arc and LED lamps, excimer lamps can be used which emit almost monochromatic vacuum ultraviolet rays with radiation typically at 172 nm. This radiation is usually used to mattify surface coatings. Excimer lamps could be used to mattify one or more of the layers composing the cycle object of the invention. They could be used to mattify the wear layer without the need to apply subsequent layers (finish) and/or used to mattify the finish itself. Excimer technology normally involves irradiation in an inert atmosphere (N2) and subsequent polymerization using traditional arc lamps.

According to an embodiment that can be provided alternatively or in combination with one or more of the other embodiments provided it is not technically contradictory, the application of the various layers composing the decorative cycle is carried out in multiple phases. It is useful in the case of the embossable layer which can be applied in large quantities to maximize embossing depth.

In a preferred form of the invention, printing is of the inkjet type. Inkjet printing can be either in multipass/scanning mode where the image is generated with multiple passes of the head while the material to be decorated advances or in single-pass mode, where the material to be printed passes only once under the heads installed corresponding to the width of the same material. Single-pass printing is used for large runs (>1000 m2/h) while multipass printing, used for small and medium runs (10-600 m2/h), is the most common. Typically, inkjet printing involves the use of a head to generate and eject liquid droplets that will then form the image to be printed. For example, details of this type of printing can be found in the book “Fundamentals of inkjet printing: the science of inkjet and droplets” (Hoath Stephen). Depending on the inkjet head used, the droplets produced can have different volumes and consequently different diameters. In addition to the native droplet size, an intrinsic characteristic of the head, it is possible to generate larger droplets from the head itself. For example, a head capable of printing 4 gray levels will have the smallest droplet of 6 pl while the largest will be 18 pl. In addition to inkjet printing, it is possible to use digital toner printing (laser), liquid toners (HP INDIGO type) or traditional analog printing such as flexography, typography, lithography, gravure, screen printing and combinations thereof.

According to an embodiment that can be provided alternatively or in combination with one or more of the other embodiments provided it is not technically contradictory, the film to be decorated is preheated to the same temperature as the central drum. Temperature, in fact, has a considerable influence on print quality as the expansion of the droplet on the film to be decorated also depends on the temperature of the film itself. In general, the higher the temperature, the greater the droplet expansion.

According to an embodiment that can be provided alternatively or in combination with one or more of the other embodiments provided it is not technically contradictory, in-line quality control is performed. This system is in fact capable of obtaining the emission or transmission spectrum of the printout and, for example, of comparing it with a standard printout, highlighting any differences. In case of anomalies, the system can also provide information to adjust the heads and avoid further deviations.

According to an embodiment that can be provided alternatively or in combination with one or more of the other embodiments provided it is not technically contradictory, in-line coating thickness control is carried out by using a suitable measurement system, for example, by measuring the variation of electrostatic capacitance between the common electrode and the sensor electrode.

In a preferred form of the invention, the ready-to-laminate film (decorated with the image, coated with the embossed textured formulation on the upper side and with the pre-polymerized adhesive on the lower side) is laminated on at least part of a substrate to be decorated. Lamination occurs through the use of heat and/or pressure. The pre-polymerized adhesive on the ready-to-laminate film allows to lower the lamination temperature compared to traditional hot lamination without adhesive, reducing the risk of damaging the flexible ready-to-laminate film.

In a preferred embodiment, the adhesive can be applied not only on the side of the flexible film opposite to that decorated with the embossable layer, but also directly on the substrate to be decorated before the lamination phase. This supplementary application of adhesive on the substrate, in combination with the adhesive already present on the ready-to-laminate film, greatly facilitates the adhesion between the layers and allows a further reduction of the temperature necessary for lamination. The adhesive applied on the substrate to be decorated can be identical to the adhesive present on the ready-to-laminate film, or it can be a different adhesive, chosen according to the specific materials that must be coupled to maximize affinity and adhesion strength. Between the two adhesive layers, or between an adhesive layer and another adjacent lamination layer, a chemical reaction can also occur to further improve adhesion or structural properties. For example, one layer may contain isocyanate groups and the next and/or previous adjacent layer may contain hydroxyl groups forming a urethane-type bond between said two adjacent layers. This is particularly advantageous when laminating materials with different chemical affinities (for example, PP and PVC), or when it is desired to further minimize thermal stress on the film or substrate, helping to prevent deformations and improve the stability of the final product.

In an executive embodiment of the invention, the flexible film decorated and coated with the embossable layer is applied directly, in single-plank mode, on a finished element such as a plank already finished with the interlocking system. Advantageously, the application of the ready-to-laminate film could be extended to the bevel, thus avoiding subsequent coloring of the bevel to unify its color with the surface color of the plank itself. The bevels commonly used in the production of floors are micro bevel, painted bevel, pressed bevel. The plank is then embossed mechanically and/or digitally, and the film is trimmed directly during the embossing phase or before or after it. This application mode is highly requested by the market as it could allow just-in-time production where planks equipped with the interlocking system but not decorated are finished by applying the flexible support produced with the method of the invention. Preferably the ready-to-laminate film is adhesive on the non-decorated side and applied by means of heat and/or pressure. The embossing, if not already present in the ready-to-laminate film object of the invention, could be generated simultaneously with the lamination phase or subsequently thereto. Advantageously for single-plank application, lamination could occur using an adhesive which allows a lower lamination temperature, thus reducing the risk of deformation of the planks of material to be decorated. The adhesive can be applied on the non-printed face of the decorated film or alternatively on the material to be decorated before applying the ready-to-laminate film object of the invention. After application, the excess ready-to-laminate film is trimmed, thus obtaining the decorated and embossed plank.

According to an embodiment that can be provided alternatively or in combination with one or more of the other embodiments, provided it is not technically contradictory, the single plank could be produced by applying the ready-to-laminate film to the single plank cut to size but without the interlocking system, and subsequently the plank would be profiled to generate the interlocking system. As a rule of thumb, the bevel can subsequently be painted to unify the color with the decor. Currently, the bevel is colored by inking with disc or roller systems, or alternatively with direct inkjet printing or by applying transfer films. Direct inkjet printing for decoration would seem the most interesting due to the case of color change and operational simplicity. On the other hand, direct inkjet printing presents limitations due to the small size of the bevel, with potential “soiling” of areas near the bevel itself, and at the same time, difficulty in achieving the desired opacity.

The applicant has found a method and apparatus for coloring the bevel that overcomes the limitations of the state of the art. In fact, it is possible to use an indirect inkjet printing technology. The color is generated by the inkjet head on a roller which, in turn, by rotating transfers the color to the bevel to be colored. This avoids soiling the areas near the bevel itself. The roller is made of a material suitable for transferring the deposited ink, and for example, the same materials used for making pad printing pads can be employed. The transfer roller can advantageously be translated to continue coloring the edge while the inkjet head applies ink to the roller surface where the ink has already been transferred. Preferably the ink is of photo-crosslinkable nature and subsequently after application is photocrosslinked by suitable irradiation systems already described above.

In a further embodiment of the invention, before applying color to the bevel, a fluid is applied to homogenize the surface of the bevel, which after profiling may be porous and generally inhomogeneous. The fluid, preferably of photo-crosslinkable nature, is applied with a system entirely analogous to that used for coloring the bevel itself. Preferably, the coloring of the bevel occurs through the application of a first white layer that serves to homogenize the surface and facilitate color matching, followed by the color that can be mainly realized in two ways. In the first way, the desired tint is realized by successive overlapping of colors. To avoid contamination of colors due to wet-on-wet application, the overlapping of layers occurs between dry layers. Preferably photo-polymerizable inks are used and the overlapping occurs by gelling/polymerizing each layer before applying the next one and for this purpose, the typical transparency of photocrosslinkable inkjet inks can be advantageously exploited. In another form of the invention, solid colors such as brown, black, green are used. Dosing by inkjet deposition allows to apply gradations of the solid tint and consequently from black different gradations of gray can be obtained and so on.

According to an embodiment that can be provided alternatively or in combination with one or more of the other embodiments provided it is not technically contradictory, the ready-to-laminate film object of the invention could be used to decorate boards with pressed bevel. The pressed bevel technology enhances the appearance of resilient flooring making it even closer to real wood. With this technology, the edges of a resilient flooring panel are pressed downwards into a bevel, ensuring that the decorative layer and texture of the panel continue until the deepest point of the bevel. To create the pressed bevel, SPC boards (PVC core+decorated film+PVC wear layer+topcoat) are pressed with a specific mold. Due to the tension between all layers and the non-thermoplastic behavior of the photocrosslinkable finish, often during pressing, cracks are formed in the various layers.

In addition to its use for producing architectural materials, the method and formulation object of the invention in any of the embodiments described above can also be used for the decoration of leather and derivatives and for the embellishment in paper converting and cards or for packaging. Furthermore, the method and the embossable layer object of the invention in any of the embodiments described above can be used to produce functional microstructures such as hydrophobic structures, microchannels and in general for microfluidics. In addition, the method and the embossable layer object of the invention in any of the embodiments described above can be used for the embossing of commercial prints and/or labels.

The following embodiments are provided for the sole purpose of illustrating the present invention and must not be understood as limiting the scope of protection defined by the attached claims.

### EXAMPLES

### Example 1

Creation of PVC film ready for lamination, mechanically embossed and pre-adhesivized, low-temperature lamination on PVC substrate.

### General Data:

Single-pass inkjet printer NBM360D (ex ZEEfarm IT) equipped with double central drum with the following characteristics:

First central drum (1200 mm), thermoregulated at 30° C. on which the following operations are performed:
Application of photocrosslinkable primer by slot-die;
Polymerization of primer by LED395+365;
5-color printing (CRYKLk);
LED pinning after each color;
Polymerization of printing by LED395;
Application of photocrosslinkable wear layer by slot-die;
Polymerization of photocrosslinkable wear layer by LED395+365

Second central drum, heated at 120° C., mechanical embossing:
Embossing paper unwinder (SURTECO Realtecs K140 Oak 100 μm).
Film tensioning system
Cooled embossing calender (25° C.)
Embossing paper rewinder Film width: 360 mm
Line speed: 30 m/min.

A printing primer composed of:
Acrylate monomer, HDDA: 83.9%
Radical photoinitiator, Photomer 1173: 5%
Radical photoinitiator, Photomer TPO-L: 1%
Wetting additive, Tego glide 432:0.1%
Thermoplastic resin, DEGALAN P24: 10%

The primer was photopolymerized with an LED395 lamp (1386 mJ/cm²).

Subsequently, the film was inkjet printed (ZEEtree UV inkjet inks DéCOR series: Cyan, Red, Yellow, Black, Gray). After each color, the ink was gelled to control droplet expansion using an LED lamp (maximum power 2 w/cm²). Subsequently, the image was polymerized using 395 nm LED (1386 mJ/cm²).

Subsequently, 150 g/m² of embossable layer composed as follows (in parts) were applied by slot-die:
Acrylate monomer, DPGDA: 45
Urethane acrylate with Mw 2000 and functionality 3:20
Radical photoinitiator, Photomer 1173:5
Radical photoinitiator, Photomer TPO-L: 1
Wetting additive, Tego glide 432:0.1
Thermoplastic resin, DEGALAN P24: 10
Aluminum oxide F230: 20

On the inner side, opposite to the printed side, of the film to be decorated, 8 g/m² of adhesive composed as follows (parts) were applied by slot-die:
HDDA: 83.9
Radical photoinitiator, Photomer 1173:5
Radical photoinitiator, Photomer TPO-L: 1
Wetting additive, Tego glide 432:0.1
Vinyl acetate-based thermoplastic resin: 15

The formulation was then polymerized by irradiation with LED 395 nm (1386 mJ/cm²).

On the second central drum, the film is pressed in contact with the embossing paper between the cooled calender and the heated central drum, thus reproducing the negative of the embossing paper texture.

After the various applications, the decorated and coated film is flexible and can be rewound without damage on the 3″ core.

Subsequently, the ready-to-laminate film was laminated on an SPC plank (ex-SENTAI, PVC, 4.2 mm) with the following conditions:
Line speed: 15 m/min
Application of the same adhesive used on the film by coater: 8 g/m2
Polymerization of adhesive by irradiation with Hg lamp (200 mJ/cm²)
Heating of substrate surface to 80° C. by NIR lamp
Coupling of ready-to-laminate film with rubber calender (EPDM, 80 ShA) heated to 80° C. Gap between calender cylinders 3.8 mm

The substrate laminated with the ready-to-laminate film was then irradiated with an Hg lamp (220 mJ/cm²).

The sample was successfully tested simulating the most common processes such as cutting, drilling and profiling and was also tested for the following properties:

| TEST | NORM | VALUE | |
|---|---|---|---|
| Abrasion | EN 13329 | AC5 | |
| Resistance to micro | | B2 | |
| scratches method B | | | |
| Curling | ISO 23999 | 0.6 | mm |
| Texture depth | | Max 120 | μ |

### Example 2

Creation of BOPP film ready for lamination, cast-cure embossed and pre-adhesivized, low-temperature lamination on pre-adhesivized PP substrate.

### General Data:

Single-pass inkjet printer NBM360D (ex ZEEfarm IT) equipped with central drum with the following characteristics:

First central drum (1200 mm), thermoregulated at 30° C. on which the following operations are performed:
Application of photocrosslinkable primer by slot-die;
Polymerization of primer by LED395+365;
5-color printing (CRYKLk);
LED pinning after each color;
Polymerization of printing by LED395;

Second central drum (1200 mm), thermoregulated at 30° C. on which the following operations are performed. (cast cure emboissing):
Application of photocrosslinkable wear layer by slot-die;
Release film unwinder (SURTECO Realtecs K140 Oak 100 μm)
Film tensioning system
UV Hg lamp for curing through the film
Release film rewinder
Film width: 360 mm
Line speed: 30 m/min

A printing primer composed of:
Acrylate monomer, HDDA: 83.9%-
Radical photoinitiator, Photomer 1173: 5%-
Radical photoinitiator, Photomer TPO-L: 1%-
Wetting additive, Tego glide 432:0.1%-
Thermoplastic resin, DEGALAN P24: 10%

The primer was photopolymerized with an LED395 lamp (1386 mJ/cm²).

Subsequently, the film was inkjet printed (ZEEtree UV inkjet inks DéCOR series: Cyan, Red, Yellow, Black, Gray). After each color, the ink was gelled to control droplet expansion using an LED lamp (maximum power 2 w/cm²). Subsequently, the image was polymerized using 395 nm LED (1386 mJ/cm²).

Subsequently, 120 g/m² of embossable layer composed as follows (in parts) was applied by slot-die:
Acrylate monomer, DPGDA: 45
Urethane acrylate with Mw 2000 and functionality 3:20
Radical photoinitiator, Photomer 1173:5
Radical photoinitiator, Photomer TPO-L: 1
Wetting additive, Tego glide 432:0.1
Thermoplastic resin, DEGALAN P24: 10
Aluminum oxide F230: 20

On the inner side, opposite to the printed side, of the film to be decorated, 8 g/m² of adhesive composed as follows (parts) was applied by slot-die:
IBOA monomer: 83.9
Radical photoinitiator, Photomer 1173:5
Radical photoinitiator, Photomer TPO-L: 1
Wetting additive, Tego glide 432:0.1
Vinyl acetate-based thermoplastic resin: 15

The formulation was then polymerized by irradiation with LED 395 nm (1386 mJ/cm²).

On the second central drum, the release film is brought into contact with the decorated film on which the embossable layer has been applied and simultaneously irradiated through the release film, immediately after the film is removed by rewinding it for subsequent use; thus the negative of the embossing film texture is reproduced, in this case the texture of an oak. After the various applications, the decorated and coated film is flexible and can be rewound without damage on the 3″ core.

Subsequently, the ready-to-laminate film was laminated on a PP plank (Polyco, 4.2 mm) with the following conditions:
Line speed: 15 m/min
Application of the same adhesive used on the film by coater: 8 g/m2
Polymerization of adhesive by irradiation with Hg lamp (200 mJ/cm²)
Heating of substrate surface to 80° C. by NIR lamp
Coupling of ready-to-laminate film with rubber calender (EPDM, 80 ShA) heated to 80° C. Gap between calender cylinders 3.8 mm

The substrate laminated with the ready-to-laminate film was then irradiated with an Hg lamp (220 mJ/cm²).

The sample was successfully tested simulating the most common processes such as cutting, drilling and profiling and was also tested for the following properties:

| TEST | NORM | VALUE | |
|---|---|---|---|
| Abrasion | EN 13329 | AC4 | |
| Resistance to micro | | B2 | |
| scratches method B | | | |
| Curling | ISO 23999 | 0.2 | mm |
| Texture depth | | Max 120 | μ |

### Example 3

Creation of PVC film ready for lamination, digital embossing, low-temperature lamination on PVC substrate, digital texture release (creation) and application of protective finish (topcoat).

### General Data:

Single-pass inkjet printer NBM360D (ex ZEEfarm IT) equipped with double central drum with the following characteristics:

First central drum (1200 mm), thermoregulated at 30° C. on which the following operations are performed:
Application of photocrosslinkable primer by slot-die;
Polymerization of primer by LED395+365;
5-color printing (CRYKLk);
LED pinning after each color;
Polymerization of printing by LED395;

Second central drum (1200 mm) on which the following operations are performed:
Application of photocrosslinkable wear layer to be textured by slot-die;
Application of digital texturization fluid by inkjet;
Polymerization of photocrosslinkable wear layer by LED395+365;
Photocrosslinkable digital protective paint by slot-die;
Film width: 360 mm
Line speed: 30 m/min
Central drum thermoregulated at 30° C.

To a white PVC film (70μ Mondorevine) 6 g/m² of a printing primer consisting (in parts) were applied by slot-die:
Acrylate monomer, HDDA: 85
Radical photoinitiator, Photomer 1173:5
Radical photoinitiator, Photomer TPO-L: 1
Wetting additive, Tego glide 432:0.1
Thermoplastic resin, VINNOL H 30/48M: 10

The primer was photopolymerized with a 395 nm LED lamp (1386 mJ/cm²).

The film was then inkjet printed (ZEEtree UV inkjet inks DéCOR series: Cyan, Red, Yellow, Black, Gray). After each color, the ink was gelled using an LED pinning lamp (maximum power 2 w/cm²) to control droplet expansion. Subsequently, the image representing a medium oak wood was polymerized using 395 nm LED (1386 mJ/cm²).

Subsequently, 30 g/m² of matt wear layer formulated as follows (in parts) were applied by slot-die:
Acrylate monomer, DPGDA: 45
Urethane acrylate with Mw 2000 and functionality 3:20
Radical photoinitiator, Photomer 1173:5
Radical photoinitiator, Photomer TPO-L: 1
Wetting additive, Tego glide 432:0.1
Thermoplastic resin, VINNOL H 30/48M: 10
Silica: 10
Aluminum oxide F320: 10

The formulation was then polymerized by irradiation with LED 365 (782 mJ/cm²)+LED 395 nm (1386 mJ/cm²).

On the inner side, opposite to the printed side, of the film to be decorated, 8 g/m² of adhesive composed as follows (parts) were applied by slot-die:
Hydroxylated acrylate monomer, 4-BA: 83.9
Blocked isocyanate (unblocking T 110° C.): 5
Radical photoinitiator, Photomer 1173:5
Radical photoinitiator, Photomer TPO-L: 1
Wetting additive, Tego glide 432:0.1
Thermoplastic resin, VINNOL 15/45 M: 10

The formulation was then polymerized by irradiation with LED 395 nm (1386 mJ/cm²).

150 g/m² of the wear layer to be digitally embossed (embossable layer) were then applied on the second central drum as follows:
Acrylate monomer, DPGDA: 45
Urethane acrylate with Mw 2000 and functionality 3:20
Radical photoinitiator, Photomer 1173:5
Radical photoinitiator, Photomer TPO-L: 1
Wetting additive, Tego glide 432:0.1
Thermoplastic resin, VINNOL H 30/48M: 10
Aluminum oxide F220: 20

The following digital texturization fluid (in parts) was then applied:
Acrylate monomer, DPGDA: 95
Tinuvin 400:5

Finally, 6 g/m² of the protective coating formulated as follows (in parts) were applied by slot-die:
Acrylate monomer, DPGDA: 75
Acrylate monomer, dipentaerythritol pentaacrylate: 20
Radical photoinitiator, Photomer 1173:5
Radical photoinitiator, Photomer TPO-L: 1
Wetting additive, Tego glide 432:0.1

The film surface is dry to the touch and the film is rewound.

Subsequently, the ready-to-laminate film was laminated on an SPC plank (ex-SENTAI, PVC, 4.2 mm) with the following conditions:
Line speed: 15 m/min
Application of the same adhesive used on the film by coater: 8 g/m2
Polymerization of adhesive by irradiation with Hg lamp (200 mJ/cm²)
Heating of substrate surface to 80° C. by NIR lamp
Coupling of ready-to-laminate film with rubber calender (EPDM, 80 ShA) heated to 80° C. Gap between calender cylinders 3.8 mm

In the subsequent phase, three-dimensionality was released by mechanically removing the areas on which the digital texturization fluid had been printed.

The substrate on which the ready-to-laminate film was applied was brushed with QUICKWOOD CDI/300 brushing machine equipped with 3 groups of steel brushes with wire diameter 0.3 mm. After brushing, the three-dimensional structure generated on the decorated substrate is well-defined and detailed.

The substrate laminated with the ready-to-laminate film was then irradiated with an Hg lamp. 10 g/m² of finishing coating composed as follows (in parts) were then applied by coater:
Acrylate monomer, DPGDA: 65
Urethane acrylate with Mw 3500 and functionality 8:15
Radical photoinitiator, Photomer 184:5
Radical photoinitiator, Photomer TPO-L: 1
Wetting additive, Tego glide 432:0.1
Silica SYLOID 162C: 15

The formulation was then polymerized by irradiation with LED 365 (782 mJ/cm²)+LED 395 nm (1386 mJ/cm²).

The digitally decorated and textured substrate was tested as follows:

| TEST | NORM | VALUE | |
|---|---|---|---|
| Abrasion | EN 13329 | AC5 | |
| Resistance to micro | | B1 | |
| scratches method B | | | |
| Curling | ISO 23999 | 0.5 | mm |
| Texture depth | | Max 120 | μ |

### Example 4

Use of pre-adhesivized BOPP film ready for lamination, single-plank lamination. The ready-to-laminate pre-adhesivized BOPP film was prepared as in EXAMPLE 2.

Subsequently, the ready-to-laminate film was laminated on a PP plank (POLYCO, 4.2 mm) already profiled (I4F DROP-LOCK) with the following conditions:
Line speed: 15 m/min
   Application of the same adhesive used on the film by coater: 8 g/m2
   The low Sh applicator cylinder (50 ShA) allows adhesive application also on the bevel
   Polymerization of adhesive by irradiation with Hg lamp (200 mJ/cm²)
   Heating of substrate surface to 80° C. by NIR lamp
   Coupling of ready-to-laminate film with rubber calender (EPDM, 80 ShA) heated to 80° C. Gap between calender cylinders 3.8 mm

The film is well adhered to the surface and bevel, excess film is removed manually with a suitable tool.

The decorated and embossed substrate was tested as follows:

| TEST | NORM | VALUE | |
|---|---|---|---|
| Abrasion | EN 13329 | AC5 | |
| Resistance to micro | | B2 | |
| scratches method B | | | |
| Curling | ISO 23999 | 0.3 | mm |
| Texture depth | | Max 120 | μ |

### Example 5

Use of pre-adhesivized PVC film ready for lamination, simulation of kissing lamination after extrusion.

The ready-to-laminate pre-adhesivized PVC film was prepared as in EXAMPLE 1.

Subsequently, the ready-to-laminate film was laminated on core (PVC, SENTAI, 4.2 mm) heated in oven to 100° C. with the following conditions:
Line speed: 5 m/min
Coupling with rubber calender (EPDM, 80 ShA) heated to 80° C. Gap between calender cylinders 3.8 mm

“Kissing” lamination implies the use of low pressure and the pre-adhesivized film allows lamination at lower temperature compared to traditional lamination (<150° C.), thus avoiding damage to the film and alteration of embossing.

The film is well adhered to the surface and bevel, excess film is removed manually with a suitable tool.

The decorated and embossed substrate was tested as follows:

| TEST | NORM | VALUE | |
|---|---|---|---|
| Abrasion | EN 13329 | AC5 | |
| Resistance to micro | | B2 | |
| scratches method B | | | |
| Curling | ISO 23999 | 0.6 | mm |
| Texture depth | | Max 120 | μ |

1. A ready-to-laminate film for decorating a material, comprising:
(a) a flexible film;
(b) a decorative layer applied on at least part of one side of said flexible film;
(c) an embossable layer applied on at least part of said flexible film, arranged on or over said decorative layer or interposed between said flexible film and said decorative layer, said embossable layer comprising a photo-curable formulation and at least one thermoplastic resin, and said embossable formulation being embossed with a three-dimensional structure by cast-curing; and
(d) an adhesive layer applied on the side of said flexible film opposite to where said embossable layer and/or said decorative layer is applied, said adhesive layer comprising a photo-curable formulation and at least one thermoplastic resin, and said adhesive layer being pre-photopolymerized and thermally reactivatable.

2. The ready-to-laminate film according to claim 1, wherein said embossable layer comprises an anti-abrasive filler in an amount between 10% and 30% by weight.

3. The ready-to-laminate film according to claim 2, wherein said anti-abrasive filler is aluminum oxide with a size greater than 50u.

4. The ready-to-laminate film according to claim 1, characterized by a loss of structure due to polymer relaxation of less than 10% after 12 hours at 60° C.

5. The ready-to-laminate film according to claim 1, wherein the thermoplastic resin in at least one of said embossable layer and/or said adhesive layer is functionalized with chemical groups selected from maleic, hydroxyl, carboxyl, amino, isocyanate, and glycidyl groups.

6. The ready-to-laminate film according to claim 5, wherein at least one of said embossable layer and/or said adhesive layer is subjected to a secondary crosslinking (dual-cure) process.

7. The ready-to-laminate film according to claim 1, wherein the embossable layer presents areas with different gloss, replicating the gloss variations of a textured transparent film used in cast-curing.

8. The ready-to-laminate film according to claim 1, wherein said adhesive layer is capable of lowering the lamination temperature compared to traditional lamination performed without adhesive and/or making chemically different materials compatible.

9. The ready-to-laminate film according to claim 1, characterized by a deformation (bending/curling/cupping) of less than 1 mm after 6 hours at 80° C. without the use of a backcoating.

10. The ready-to-laminate film according to claim 1, wherein said flexible film is selected from paper, PE, PP, PET, ABS, PVC, aluminum, or combinations thereof.
B. Process (Method)

11. A method for producing a ready-to-laminate film for decorating a material, comprising the steps of:
(a) printing an image or a uniform color on at least part of a flexible film and photopolymerizing/drying the ink;
(b) applying an embossable formulation, consisting of a photo-curable formulation containing at least one thermoplastic resin, to at least part of the flexible film;
(c) embossing said embossable layer by cast-curing, comprising applying a textured transparent film onto the surface of said embossable layer, photopolymerizing said embossable layer while in contact with said textured transparent film, and subsequently removing said textured transparent film; and
(d) applying an adhesive, consisting of a photo-curable formulation containing at least one thermoplastic resin, on the side of said flexible film opposite to where said embossable layer and/or said decorative layer has been applied and pre-photopolymerizing said adhesive.

12. The method according to claim 11, wherein step (a) of applying the decorative layer is by inkjet digital printing.

13. The method according to claim 11, further comprising the step of laminating said ready-to-laminate film onto a material to be decorated, reactivating said adhesive layer by heat and/or pressure.

14. The method according to claim 13, further comprising the step of applying an additional adhesive onto the material to be decorated prior to laminating said ready-to-laminate film.

15. The method according to claim 14, wherein the adhesive applied to the material to be decorated is identical to or different from the pre-photopolymerized adhesive on the film.

16. The method according to claim 13, wherein a chemical reaction occurs between the adhesive on the film and the adhesive on the material to be decorated, or between one adhesive layer and another adjacent lamination layer, during or subsequent to lamination.

17. The method according to claim 13, wherein the lamination is performed on a single pre-profiled plank, extending the application of the film to the bevel of said plank.

18. The method according to claim 11, wherein step (c) of embossing the film is, alternatively or in combination with cast-curing:
(e) mechanical embossing, wherein the embossable formulation is photopolymerized/dried before embossing, and the embossing is then mechanically performed on the already polymerized embossable layer; or
(f) digital embossing, wherein the embossable formulation, still liquid or partially polymerized, receives a digital print of specific areas where the texture will subsequently be released/created, and the photopolymerization of the embossable formulation occurs after this digital print, and the texture is then released in the pre-printed areas through a selective removal process.

19. The method according to claim 18, wherein the digital embossing is followed by brushing of the laminated substrate to release the digitally created texture and, optionally, by the application of a finishing coating.
